(19) United States
(12) Patent Application Publication
(10) Pub. No.: US 2003/0179850 A1
(43) Pub. Date: Sep. 25, 2003

(54) X-ray fluorescence holography apparatus

(76) Inventors: Eiichiro Matsubara, Sendai-shi (JP); Koichi Hayashi, Sendai-shi (JP); Kimio Wakoh, Natori-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/246,520

(22) Filed: Sep. 19, 2002

(30) Foreign Application Priority Data
Mar. 20, 2002 (JP) 2002-079541

(51) Int. Cl. G01T 1/36

(52) U.S. Cl. 378/44

(57) ABSTRACT

The X-ray fluorescence holography apparatus includes the X-ray converging element that can irradiate monochrome X-rays onto a sample O set on the rotation table, by which a predetermined count number of the X-ray fluorescence to be collected for the X-ray detector can be achieved in a short period of time.

### CROSS-REFERENCE TO RELATED APPLICATIONS

This application is based upon and claims the benefit of priority from the prior Japanese Patent Application No. 2002-79541 filed Mar. 20, 2002, the entire contents of which are incorporated herein by reference.

### BACKGROUND OF THE INVENTION

1. Field of the Invention

The present invention relates to an X-ray fluorescence holography apparatus.

2. Description of the Related Art

As an evaluation technique with use of X rays, widely-known examples are an X-ray photography (radiograph), which can examine an internal structure of a substance of a human body or a man-made construction or the like, by utilizing the transmissibility of X rays, an X-ray diffraction which can examine an atomic structure by utilizing the diffraction phenomenon, and an X-ray fluorescence chemical (spectral) analysis which can analyze a chemical composition by measuring the X-ray fluorescence of an element, that is unique to it.

Of these examples, an attention is focused on an X-ray fluorescence holography. In this technique, a sample is excited by irradiating a high-intensity X rays onto it, and X-ray fluorescence emitted from the sample as a result are detected, thereby analyzing a local structure of the substance.

In accordance with the advancing measuring technology of recent years, the X-ray fluorescence holography is being applied to a variety of areas that has been very difficult to evaluate with the other structural analyzing techniques. More specifically, the X-ray fluorescence holography is now applied to the determination of a substituting site of a trace amount of dopant in a semiconductor or a structural analysis of a quasi-crystal.

Further, it is expected that in the future, the holography can be applied to the local structural analysis of a functional material, that is, typically, a short-range structure of a magnetic thin film or a local distortion of a superconductor, etc.

It should be noted that even today, an atomic image can be observed three-dimensionally under a certain condition from an interference pattern that is obtained by transforming measured hologram patterns in three-dimensional fourier transformation mode if the condition allows that the atom can be measured with a high-intensity X-ray for a long period of time by the X-ray fluorescence holography technique.

However, the X-ray fluorescence holography is based on the measurement of an extremely weak hologram signal, and therefore it has been very difficult to practice this technique except in large-scale radiation light facilities where high-intensity incident X-rays can be handled.

Further, the use of a large-scale radiation facility is, in usual cases, limited in terms of the time as well as the cost. Therefore, among the researches, in particular, there has been an increasing demand for development of experimental equipments that can easy perform the structural analysis of a variety of materials.

It should be noted here that the intensity of a hologram pattern of an X-ray fluorescence radiated from a sample is about 1/1000 of the intensity of the X-ray fluorescence of the background to the pattern, and therefore even if a hologram pattern can be obtained, it would generally take several weeks to about two months by general research laboratories.

Under the circumstances, the research group that includes the inventor(s) of the present invention devised a technique that was published in a document called “Materia Volume 38, No. 1 (1999)”. According to this technique, the intensity of X-rays irradiated on a sample can be increased by using an X-ray concentrating element having a certain shape to about 200 times higher as compared to the X-ray strength emitted from a conventional X-ray generating device having a hollow spherical shape.

However, even with use of the X-ray concentration element, it still requires about several weeks to obtain X-ray fluorescence of a predetermined number of counts in general research laboratories.

### BRIEF SUMMARY OF THE INVENTION

The present invention has been achieved in consideration of the above-described circumstances of the prior art techniques, and the object thereof is to provide an X-ray fluorescence holography apparatus that can obtain a desired count number of X-ray fluorescence within a short period of time to be able to form a hologram (X-ray interference) pattern.

According to an aspect of the present invention, there is provided an X-ray fluorescence holography apparatus comprising: an X-ray source for emitting a group of X-rays that includes an X-ray of a wavelength to be irradiated on a sample; an X-ray detector for detecting fluorescence radiated from the sample when the sample is excited, and output an electric signal that corresponds to the fluorescence; and an X-ray converging element for converging a characteristic X-ray of a predetermined wavelength of the group of X-rays emitted from the X-ray source towards the sample, onto the sample.

According to another aspect of the present invention, there is provided an X-ray fluorescence holography apparatus comprising an X-ray source for emitting a group of X-rays that includes an X-ray of a wavelength to be irradiated on a sample, and an X-ray detector for detecting fluorescence radiated from the sample when the sample is excited, and output an electric signal that corresponds to the fluorescence; wherein the X-ray fluorescence holography apparatus uses an X-ray converging element for converging a characteristic X-ray of a predetermined wavelength of the group of X-rays emitted from the X-ray source towards the sample, onto the sample.

According to still another aspect of the present invention, there is provided a local structure analyzing method that uses an X-ray source for emitting a group of X-rays that includes an X-ray of a wavelength to be irradiated on a sample and an X-ray detector for detecting fluorescence radiated from the sample when the sample is excited, and output an electric signal that corresponds to the fluorescence, for obtaining a three-dimensional image of a sample by image-processing an electrical signal outputted from the X-ray detector, wherein the method further uses an X-ray converging element for converging a characteristic X-ray of a predetermined wavelength of the group of X-rays emitted from the X-ray source towards the sample, onto the sample.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram illustrating an example of an X-ray fluorescence holography apparatus according to an embodiment of the present invention;

FIG. 2 is a schematic diagram illustrating an example of arrangement of the structural elements of the X-ray fluorescence holography apparatus shown in FIG. 1;

FIG. 3 is a photograph showing an atomic image of copper visualized from a hologram pattern obtained by the X-ray fluorescence holography apparatus shown in FIGS. 1 and 2; and

FIG. 4 is a schematic diagram illustrating an example of a local analytic image of a copper atom, obtained by three-dimensional-Fourier-transforming the hologram pattern obtained by the X-ray fluorescence holography apparatus illustrated in FIGS. 1 and 2.

### DETAILED DESCRIPTION OF THE INVENTION

An embodiment of the present invention will now be described in detail with reference to accompanying drawings.

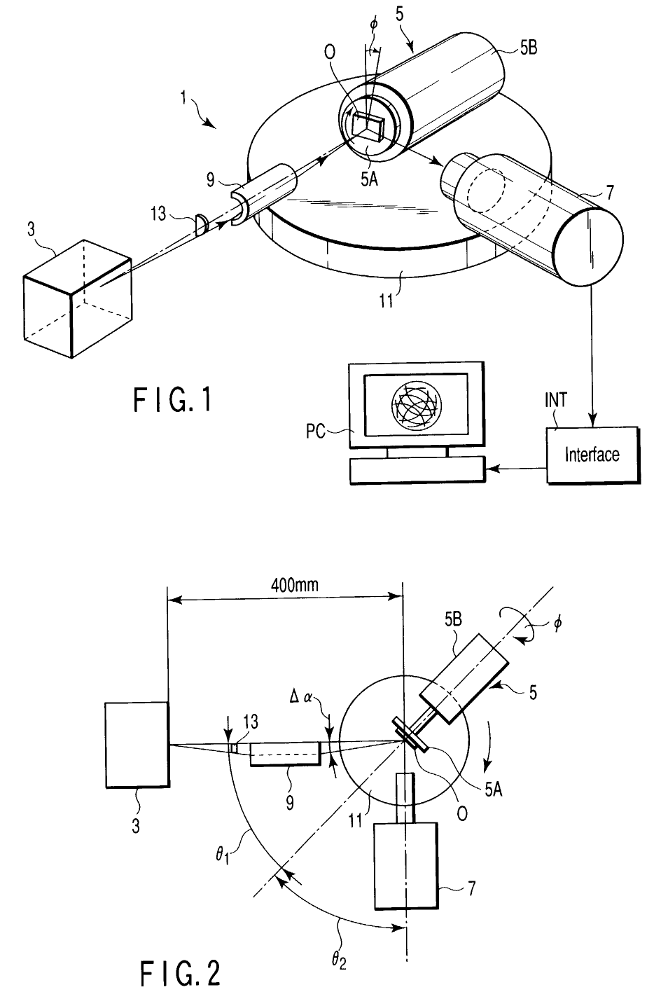

FIG. 1 is a schematic diagram illustrating an example of the X-ray fluorescence holography apparatus according to an embodiment of the present invention.

An X-ray holography apparatus 1 includes an X-ray generating device 3 serving as an X-ray source radiates X-rays of continuous wavelengths and a characteristic X-ray of a predetermined wavelength, a rotation stage 5 holds a sample to be measured thereon and rotate it at a predetermined number of revolutions, and an X-ray detector 7 detects an interference (hologram) pattern of X-rays (X-ray fluorescence) emitted from the sample O. An output from the X-ray detector 7 is stored in an image processing device, for example, a personal computer PC via an interface INT.

At a predetermined position between the rotation stage 5 and the X-ray generating device 3, an X-ray converging element 9 is provided, which serve to converge an X-ray of a predetermined wavelength, that is, a characteristic X-ray, of X-rays of continuous wavelengths directed onto the sample 0 from the X-ray generating device 3, at a predetermined region (an arbitrary point) of the sample O. An angle made by an incident X-ray and the sample O, that is, the angle of the X-ray irradiated on the sample O (the irradiation angle of the excitation X-ray) can be arbitrarily set within a predetermined range, as will now be described. Since, each of the rotation stage 5 and the X-ray detector 7 is held by a 2-axial stage or a turntable 11, which is rotated with a predetermined step or angle. A stopper 13 is disposed between the X-ray generating device 3 and the X-ray converging element 9, and the stopper 13 can set the cross section of the X-ray flux made incident on the X-ray converging element 9 into a desired shape. It should be noted that alternatively, a monitor device (I₀ monitor) may be provided between the X-ray converging element 9 and the sample O (or the rotation stage 5), in order to monitor the strength of the X-rays irradiated onto the sample O (to be measured).

The X-ray generating device 3, here, is, for example, an X-ray tube of a rotating target type. The X-ray fluorescence holography apparatus shown in FIG. 1, employs an X-ray generating device commercially available in the market, that uses Mo for the anode target and has a rated power of 21 kW. It is only natural that the present invention is not limited particularly to the rotating target type X-ray tube as long as it is capable of generating X-rays of a predetermined intensity or higher.

It should be noted that the wavelengths of the characteristic X-rays radiated from the X-ray generating device 3 are as follows. That is, when Mo is used as the target, the MoKα-ray is obtained, and its wavelength is 0.071 nm. When the target is Mo, MoKβ-ray can be used as well, and its wavelength is 0.063 nm. It should be noted here that when both of Kα-ray and Kβ-ray are used, a hologram can be recorded with X-rays of two difference wavelengths that are irradiated onto the sample O, and therefore it is possible to reproduce an atomic image at a higher accuracy than the case of one ray.

Furthermore, the characteristic X-ray emitted from the X-ray generating device 3 when using W as the target is WLα-ray, and its wavelength is 0.147 nm. When the target is W, WLβ-ray and WLγ-ray can be used as well, and their wavelengths are 0.128 nm and 0.110 nm, respectively. That is, when W is used as the target, there are three characteristic X-rays of 3 wavelengths that can be used for making the sample O to radiate fluorescence light. Therefore, it is possible to perform the imaging of an atom even at a higher accuracy than the case of using two rays with difference wavelengths.

The rotation stage 5 has a structure in which a mount table 5A on which a sample O to be measured can be fixedly placed is integrally mounted on the rotation shaft of a conventional motor, and this motor itself is of an easily obtainable general type. The number of revolutions of the motor 5B is dependent on the composition ratio of the sample O, the shape of it (including its weight and thickness) and the count rate limit of the X-ray detector 7; however about 0.1° per sec of the revolution is a usable example.

The X-ray detector 7 is, for example, an SSD (semiconductor detector). It should be noted here that detectors with a count rate of, for example, about 10⁵ cps (counts/sec) are widely available and easily obtainable. Further, in the X-ray holography apparatus 1 shown in FIG. 1, it is not necessary to separately detect a Kα-ray and Kβ-ray, and therefore the energy resolution ΔE required for the X-ray detector 7 may only be about 1000 eV (ΔE <1000 eV). Here, it is alternatively possible to use an energy-dispersive type X-ray detector, which has higher rate than that of the above SSD, as the X-ray detector 7.

The X-ray converging element 9 is an X-ray reflector having at least an arcuate shape, that is prepared by shaping a graphite sheet having a predetermined thickness into a cylindrical or toroidal hollow body and cutting it along, for example, its rotational shaft. In this embodiment, a cylindrical graphite device (Curvature Graphite Monochrometer: a product of Matsushita Electric Industrial Co., Ltd.) having a radius of curvature of 21 mm and a length of 40 mm was used, and only the Kα-ray is irradiated (converged) onto the sample O.

Next, the arrangement of the structural elements of the X-ray holography apparatus 1 shown in FIG. 1 will now be described in detail with reference to FIG. 2.

FIG. 2 is a schematic diagram of the X-ray holography apparatus 1 as viewed from a direction vertical to a plane defined by the X-ray flux directed towards the sample O and the fluorescence (X-ray) radiated from the sample O as it is excited.

As shown in FIG. 2, in this embodiment, the distance between the X-ray generating device 3 and the rotation center of the mount table 5A of the rotation table 5 is about 400 mm although it may vary under the influence of the converging force of the X-ray converging element 9.

In FIG. 2, an angle defined by the characteristic X-ray irradiated from the X-ray generating device 3 onto the sample O and the imaginary axial line extending from the rotation shaft of the motor 5B, that is, an incident angle θ₁, is selected from a range of, for example, 70° to 90° under conditions including the shape of the sample O. It should be noted here that the minimum possible value of the incident angle θ₁ is usually 0°.

Another angle defined by the axial line extending from the rotation shaft of the motor 5B and the center axis of the X-ray incident surface (not shown) of the X-ray detector 7, that is, a detection angle θ₂ used for detecting the X-ray fluorescence radiated from the sample O is, for example, 30° to 80°. It should be noted that one detection angle θ₂ is fixed for one angle θ₁ values. In other words, while a characteristic X-ray is irradiated onto the sample O at an incident angle θ₁, the relative position of the X-ray detector 7 with respect to the sample is never varied.

In other words, θ₁ and θ₂ are set to arbitrary angles, and the sample O is rotated for 360° for each of the positions defined by the combinations of the angles. With this operation, fluorescence can be obtained from a plurality of three-dimensional positions of the sample O.

The X-ray converging element 9 in the X-ray fluorescence holography apparatus 1 shown in FIGS. 1 and 2 is a curved graphite member having a radius of curvature of 21 mm and a length of 40 mm. Here, the radius of curvature and the length are optimized in accordance with the type of sample, the wavelength of the X-ray, the output of the X-ray generating device, and the like. Further, as described above, the shape of the cross section of the X-ray flux made incident on the X-ray converging element 9 is roughly defined by the stopper 13. It should be noted that an angle of divergence Δα of the characteristic X-ray, which is defined as the maximum value of the angle made by an arbitrary one point of a reflection surface (inner surface) of the X-ray converging element (graphite) 9, a point where the characteristic X-ray is converged at maximum by the graphite 9 (that is, the center of the table 5A of the rotation stage 5), and another arbitrary point on the reflection surface of the graphite, is set to be, for example, 3° or less.

Next, the procedure of analyzing a local structure of copper with use of the X-ray holography apparatus 1 shown in FIGS. 1 and 2 will now be described together with an example of the hologram pattern obtained as a result of the analysis, and a three-dimensional atomic image (three-dimensional atomic arrangement).

That is, first, a Cu (copper) single crystal in the form of, for example, a flat plate is fixed onto the mount table 5A of the rotation table 5, and an X-ray of a predetermined wavelength, that has been made monochrome by the X-ray converging element 9, is irradiated onto the copper crystal, the sample here. While irradiating the X-ray, the rotation table 5 is continuously rotated at a predetermined rotation amount φ defined by a predetermined voltage or a predetermined drive pulse supplied from a motor driver, which is not shown, that is, for example, a speed of φ0.1°/sec. Further, the characteristic X-ray is continuously irradiated onto the sample O for a predetermined period of time until the number of photons counted at one point (, located at an arbitrary position on the sample) reaches a predetermined value.

From the sample (copper), fluorescence (X-ray) is radiated at a certain possibility. The fluorescence generated from the sample reaches an X-ray input surface, which is not shown, of the X-ray detector 7 at a certain possibility. It should be noted that usually, the amount of fluorescence that is made incident onto the X-ray detector 7 from the sample is, for example, about 10% of the entire radiation amount. Here, although it is very rare, a characteristic X-ray irradiated onto the sample O at an incident angle θ₁, in some cases, is made incident onto the X-ray detector 7 as it passes through the same track as that of the fluorescence emitted from the sample O. However, the conditions that allow a reflection X-ray to occur (Bragg conditions) are very much restricted, and therefore reflection X-rays can only occur at random and infrequent intervals (in a spot fashion). Here, by optimizing the detection angle θ₂, it is substantially possible to suppress a reflection X-ray to be made incident on the X-ray detector 7.

The intensity of a monochrome X-ray irradiated onto a sample is, for example, in photon number, about 10⁸ photons/sec. On the other hand, the degree of the radiation of fluorescence caused by excitation of the sample O is about 1/1000 of the intensity of the characteristic X-ray irradiated onto the sample. It should be noted that the number of X-rays inputted to the input surface of the X-ray detector 7 (that is, the efficiency) can be roughly estimated from the incident angle θ₁, the detection angle θ₂, the intensity of the characteristic X-ray irradiated onto the sample O, and the state of the sample (such as the size and composition thereof).

The X-ray fluorescence that has reached the X-ray detector 7, that is, an interference (hologram) pattern, is voltage-converted by an A/D converter, which is not shown, that is built in or separated from the X-ray detector 7. Then, the voltage-converted pattern is input to the personal computer PC via an interface that is not shown in the figure. In usual cases, a result obtained by storing the X-ray fluorescence (photons) radiated from the sample in a two-dimensional fashion at a 0.5° step of a step angle φ of the motor 5B ranged from 0° to 360° and at a 1° step of an incident angle θ₁ ranged from 70° to 90° is subjected to image processing by the personal computer PC. In order to carry out the image processing, it requires about 10⁶ counts of photons per one arbitrary point that is determined by azimuthal angle φ of the motor and the incident angle θ1.

The X-ray (diffraction) pattern inputted to the X-ray input surface (not shown) of the X-ray detector 7, that is, the hologram pattern depends on the variance of the intensity of the X-ray fluorescence radiated from the sample when both of or at lease either one of the rotation amount φ of the sample O (that is, the rotation angle of the table 5A) and the incident angle θ1 of the characteristic X-ray is changed, or the pattern is a function of the variance of the X-ray intensity. Therefore, if the intensity of the X-ray irradiated onto the sample O is increased and an X-ray detection with a high count rate (high speed) can be used, it is naturally possible to obtain an atomic image and three-dimensional atomic image at a high speed.

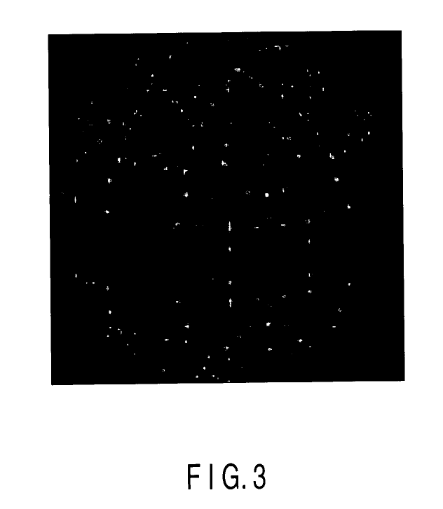

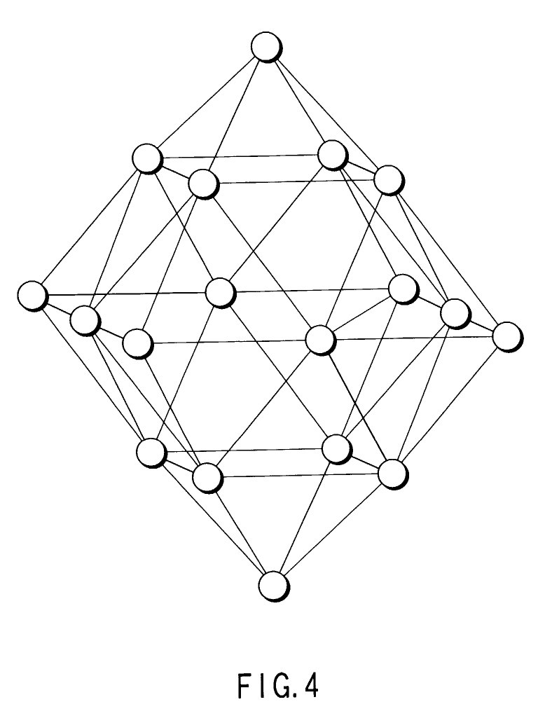

The X-ray fluorescence emitted from the sample O (that is, interference pattern) that is taken in the personal computer PC is visualized by it (PC) into an atomic image such as shown in FIG. 3. Further, with a widely available and easily obtainable algorithm for X-ray fluorescence holography (3-dimensional Fourier transformation), a three-dimensional atomic image such as shown in FIG. 4 can be obtained. (FIG. 4 is a schematic diagram showing the image illustrated by reversing black and white colors for the patent application.) It should be stressed here that with use of the above-described X-ray fluorescence holography apparatus, the measurement of an X-ray fluorescence hologram, which conventionally requires about 2 months, can be finished in about one day.

As described above, with the application of the X-ray fluorescence holography apparatus according to the present invention, it becomes possible to easily obtain a locally analyzed atomic image even in general laboratories without having to employ large-scale radiation facilities.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A X-ray fluorescence holography apparatus comprising:
an X-ray source for emitting a group of X-rays that includes an X-ray of a wavelength to be irradiated on a sample;
an X-ray detector for detecting fluorescence radiated from the sample when the sample is excited, and output an electric signal that corresponds to the fluorescence; and
an X-ray converging element for converging a characteristic X-ray of a predetermined wavelength of said group of X-rays emitted from the X-ray source towards the sample, onto the sample.

2. The X-ray fluorescence holography apparatus according to claim 1, wherein the X-ray converging element is an X-ray reflector having at least an arcuate-shape portion, that is prepared by shaping a graphite member having a predetermined thickness into a cylindrical or toroidal hollow body and cutting it along, (for example,) a rotational shaft thereof.

3. The X-ray fluorescence holography apparatus according to claim 2, wherein an angle of divergence Δα of the characteristic X-ray, which is defined as a maximum value of an angle made by an arbitrary one point of a reflection surface of the graphite member, a point where the characteristic X-ray is converged at maximum by the graphite member, and another arbitrary point on the reflection surface of the graphite, is set to be 3° or less.

4. The X-ray fluorescence holography apparatus according to claim 1, wherein the X-ray detector can count fluorescent particles emitted from the sample at a count rate of 10⁵/sec.

5. A X-ray fluorescence holography apparatus comprising an X-ray source for emitting a group of X-rays that includes an X-ray of a wavelength to be irradiated on a sample, and an X-ray detector for detecting fluorescence radiated from the sample when the sample is excited, and output an electric signal that corresponds to the fluorescence;
wherein the X-ray fluorescence holography apparatus uses an X-ray converging element for converging a characteristic X-ray of a predetermined wavelength of said group of X-rays emitted from the X-ray source towards the sample, onto the sample.

6. The X-ray fluorescence holography apparatus according to claim 5, wherein the X-ray converging element is an X-ray reflector having at least an arcuate-shape portion, that is prepared by shaping a graphite member having a predetermined thickness into a cylindrical or toroidal hollow body and cutting it along, (for example,) a rotational shaft thereof.

7. The X-ray fluorescence holography apparatus according to claim 6, wherein an angle of divergence Δα of the characteristic X-ray, which is defined as a maximum value of an angle made by an arbitrary one point of a reflection surface of the graphite member, a point where the characteristic X-ray is converged at maximum by the graphite member, and another arbitrary point on the reflection surface of the graphite, is set to be 3° or less.

8. A local structure analyzing method that uses an X-ray source for emitting a group of X-rays that includes an X-ray of a wavelength to be irradiated on a sample and an X-ray detector for detecting fluorescence radiated from the sample when the sample is excited, and output an electric signal that corresponds to the fluorescence, for obtaining a three-dimensional image of a sample by image-processing an electrical signal outputted from the X-ray detector, wherein
the method further uses an X-ray converging element for converging a characteristic X-ray of a predetermined wavelength of said group of X-rays emitted from the X-ray source towards the sample, onto the sample.

9. The local structure analyzing method according to claim 8, wherein the X-ray converging element is an X-ray reflector having at least an arcuate-shape portion, that is prepared by shaping a graphite member having a predetermined thickness into a cylindrical or toroidal hollow body and cutting it along, (for example,) a rotational shaft thereof.

10. The local structure analyzing method according to claim 9, wherein an angle of divergence Δα of the characteristic X-ray, which is defined as a maximum value of an angle made by an arbitrary one point of a reflection surface of the graphite member, a point where the characteristic X-ray is converged at maximum by the graphite member, and another arbitrary point on the reflection surface of the graphite, is set to be 3° or less.

11. The local structure analyzing method according to claim 10, wherein the three-dimensional image is obtained by image-processing the electric signal outputted from the X-ray detection with use of a three-dimensional Fourier transformation.
